(19) United States
(12) Patent Application Publication
(10) Pub. No.: US 2009/0196425 A1
(43) Pub. Date: Aug. 6, 2009

(54) Method for Authenticating Electronically Stored Information

(76) Inventor: Dean Boland, Lakewood, OH (US)

Correspondence Address: James Lindon, Lindon & Lindon, 35104 Saddle Creek, Avon, OH, 44011, US

(21) Appl. No.: 12/026,611

(22) Filed: Feb. 6, 2008

(51) Int. Cl. H04L 9/08; H04L 9/00

(52) U.S. Cl. 380/278; 380/44

(57) ABSTRACT

A system for authenticating electronically stored information (ESI) with a first key and a second key. The comparison of the first key and the second key are used to authenticate the second electronically stored information.

### BACKGROUND OF THE INVENTION

The ability to reliably ensure that electronically stored information is authentic is desirable in a number of situations. For example, courts of law, often seek to know whether digital images and other sources of electronically stored information have been altered. Publishers of digital content often seek means to insure that published content is authentic prior to participating in its publication. Electronic Voting Machines lack voter selection authentication systems to insure votes are not intentionally or unintentionally altered after their selection is made.

Various attempts to authenticate information have been largely unsuccessful or proven problematic. For example, relying on the testimony of witnesses to authenticate information in court can be problematic when witnesses die, forget or are unavailable. Various organizations have developed elaborate, expensive and divergent methods to address this problem. All of those methods suffer from the uncertainty of how a particular authority will view the legitimacy of the method's claim to establish authenticity. There remains a long-felt need for a suitable means of authenticating electronically stored information by a third party for use in legal proceedings. There remains a long-felt need for a suitable means of authenticating electronically stored information by a third party for use in business functions.

### BRIEF DESCRIPTION OF THE DRAWINGS

FIG. 1 is a schematic view of a key generation function for a system for authenticating electronically stored information in accordance with the present invention.

FIG. 2 is a schematic view of an alternate key generation function.

FIG. 3 is a schematic view of an authentication process for the system of FIG. 1.

### SUMMARY OF INVENTION

There is provided a system for authenticating electronically stored information (ESI). The system includes an ESI-creation device which executes code which generates a first electronically stored information. The system includes an ESI-storage device which executes code and stores the first electronically stored information where code generates a first key based on the first electronically stored information at a first earlier time and which transmits the first key and where code generates a second key based on a second electronically stored information at a second later time and which transmits the second key. The system includes a remote computer which executes code and receives the first key and the second key and compares the first key and the second key. The comparison of the first key and the second key are used to authenticate the second electronically stored information.

There is also provided a method for authenticating electronically stored information. The method includes providing a first electronically stored information onto a computer. The method includes producing a first key from the first electronically stored information. The method includes locating the first key at a location remote to the computer. The method includes providing a second electronically stored information. The method includes producing a second key from the second electronically stored information. The method includes comparing the first key and the second key.

There is also provided a system for authenticating electronically stored information. The system includes a device which executes code which generates a first electronically stored information and stores the first electronically stored information and executes code which generates a first key based on the first electronically stored information at a first earlier time and which transmits the first key and executes code which generates a second key based on a second electronically stored information at a second later time and which transmits the second key. The system includes a remote computer which executes code which receives the first key and the second key and compares the first key and the second key. The comparison of the first key and the second key are used to authenticate the second electronically stored information.

### DETAILED DESCRIPTION OF THE INVENTION

Preliminarily, it should be noted that certain terms used herein, such as for example above, below, upper, lower, left and right, are used to facilitate the description of the invention. Unless otherwise specified or made apparent by the context of the discussion, such terms and other directional terms should be interpreted with reference to the figure(s) under discussion. Such terms are not intended as a limitation on the position in which the invention or components may be used. Indeed, it is contemplated that the components of the invention may be easily positioned in any desired orientation for use. Likewise, numerical terms such as for example “first”, and “second” are not intended as a limitation or to imply a sequence, unless otherwise specified or made apparent by the context of the discussion. The term “operatively connected” is understood to include a linking together of the portions under consideration and may include a physical engagement and/or a functional or operational connection.

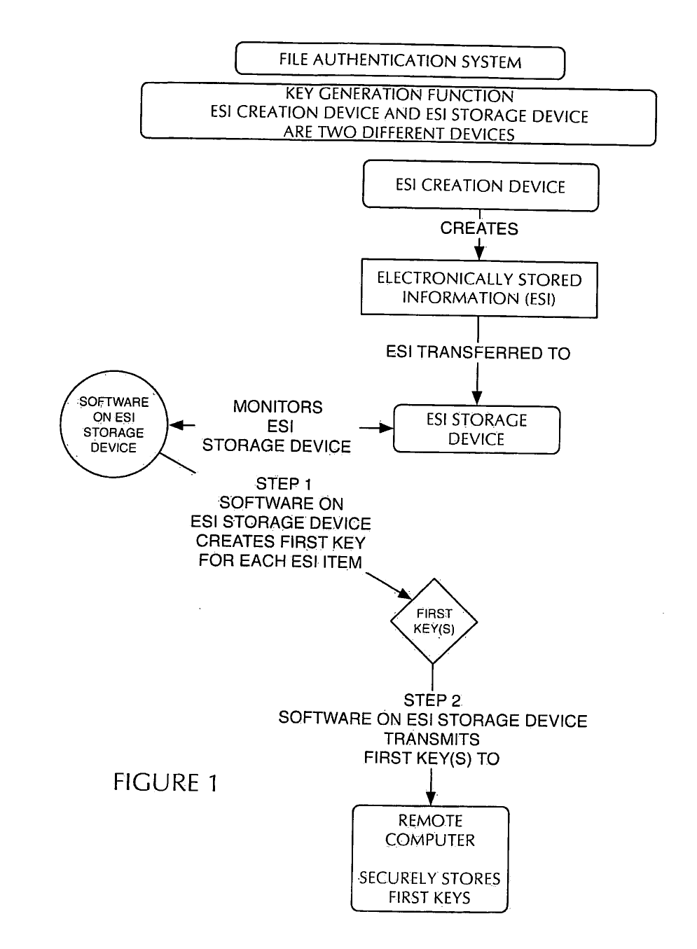

Referring now to the drawings, there is illustrated in FIGS. 1 through 3 a file authentication system according to the invention. The system may include an ESI creation device, an ESI storage device and a remote database. The ESI creation device, the ESI storage device and the remote database may be a computer. The term “computer” as used in this application may be understood to include, but is not limited to, any electronic device capable of storing and processing electronic information in accordance with a predetermined set of instructions. Non-limiting examples of computers includes PC's, servers, laptops, mobile phones, digital cameras, scanning devices and a wide variety of hand held electronic devices, and the like.

The term “hash value” as used in this application may be understood to include, but is not limited to, any value or code that is formed from a reproducible method of turning data, such as for example electronically stored information, into a unique value or code suitable to be handled by a computer. Hash values may provide a way of creating a digital “fingerprint” or “digital dna” from any kind of data or electronically store information uniquely identifying that information from all other pieces of electronically stored information. A hash value may be a key. A key may include a hash value and other information, such as an indicator of time, an account number, and the like.

The term “electronically stored information” as used in this application may be understood to include, but is not limited to, any structure or functionality which stores data in an electronic form or format. Non-exclusive examples of electronically stored information include digital images, digital videos, word processor files, text files, spread sheets, databases, and the like.

The term “legal proceeding” as used in this application may be understood to include, but is not limited to, any proceeding in which a party or other entity is advancing or defending a legal position or legal right. Non-limiting examples of legal proceedings may be understood to include, trials, hearings, taking of testimony, depositions or other discovery activities, in chamber discussions with a judge or other judicial officer, and/or any other activity where a transcript is being prepared or could be prepared.

The term “business function” as used in this application may be understood to include, but is not limited to, any activity where information is exchanged. Non-limiting examples of business functions may be understood to include, confirming that electronic files for use in business publications, documents, brochures, reports, government filings and the like are authentic prior to their use or publication. For example a business functions may include confirming that a photographic image submitted by an employee of a newspaper is authentic prior to the newspaper publishing that photographic image in an edition of the newspaper.

The term “computer” as used in this application may be understood to include, but is not limited to, any structure or functionality that accepts, processes, stores, and/or outputs data according to programmed instructions. Non-limiting examples of computers may be understood to include desktop PC's, laptop PC's, handheld PC's, mobile phones, mobile Internet devices and the like. A computer may be an ESI creation device. A computer may be an ESI storage device.

The term “ESI creation device” (electronically stored information creation device) as used in this application may be understood to include, but is not limited to, any device capable of creating an electronic file. Non limiting examples may include a computer, digital camera, mobile phone, digital xray machine, Magnetic Resonating Imaging machine, CT scan machine, and the like.

The term “ESI storage device” (electronically stored information storage device) as used in this application may be understood to include, but is not limited to, any device capable of storing an electronic file. Non limiting examples may include a computer, digital camera, mobile phone, computer, server, and the like.

These definitions are provided solely to facilitate an understanding of the invention—not to limit the invention.

In operation, the system may take a number of functional forms. Referring now primarily to FIG. 1, a key generation function is shown. A first computer generates electronically stored information (ESI). The first computer is an ESI creation device. Another type of ESI creation device may be employed. For example, the first computer may be a camera. The ESI is then stored on a second computer. The ESI is stored in an ESI storage device. For example, the ESI storage device may be a computer having one or more folders. Software on the second computer monitors the ESI storage device. When the software detects that ESI is placed into the ESI storage device, the software generates a first key. Where more than one item of ESI is placed into the ESI storage device, the software generates more than one first key. The first key, or first keys where more than one, is then transmitted to a third computer. The term “transmit” as used in this application may be understood to include, but is not limited to, any activity which sends something, passes something on, or causes something to spread, from one person, thing, or place to another. The term “transmit” as used in this application may occur, but is not limited to occurring by direct wired connection between two devices, via a mobile phone network, satellite network, via the Internet or any other such network connecting ESI storage devices and ESI creation devices with other such devices. The third computer stores the first key(s). The third computer may be a remote computer. The first key(s) may be hash value(s). FIG. 1 demonstrates a key generation function.

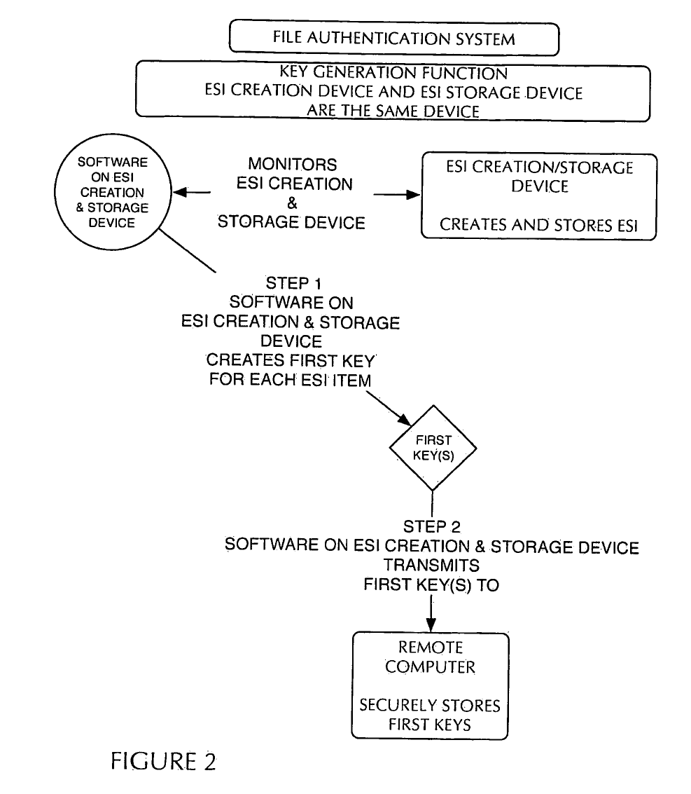

Referring now primarily to an alternate embodiment shown in FIG. 2, an alternate key generation function is shown. A first computer generates electronically stored information (ESI). The ESI is then stored on the first computer. The ESI is both created by and stored on the first computer. The first computer is an ESI creation device. The first computer is an ESI storage device. Software on the first computer monitors the ESI storage device. When the software detects that ESI is placed into the ESI storage device, the software generates a first key. Where more than one item of ESI is placed into the ESI storage device, the software generates more than one first key. The first key, or first keys where more than one, is then transmitted to a second computer. The second computer stores the first key(s). The second computer may be a remote computer. The first key(s) may be hash value(s). FIG. 2 demonstrates a key generation function.

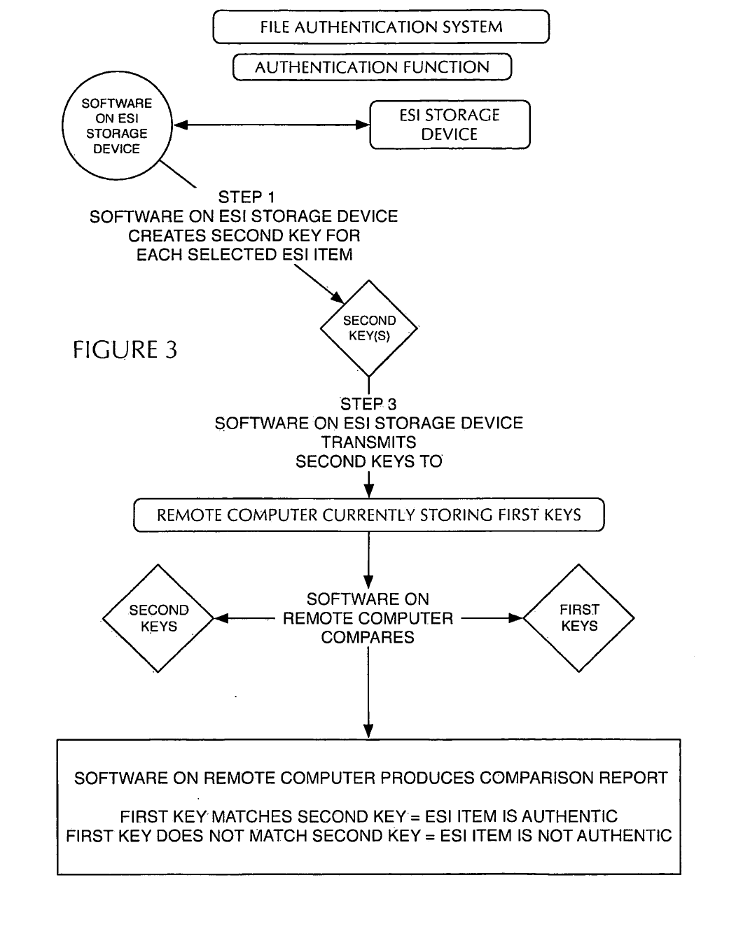

Referring now primarily to FIG. 3, an authentication function is shown. The authentication function is performed after the key generation function. The authentication function involves comparison of the first key(s) and a second key(s) from a particular piece of ESI. The ESI may be stored on a first computer—which may or may not be the same first computer as the first computer employed in the key generation function. The ESI may be stored in an ESI storage device on the first computer. Software on the first computer may monitor the ESI storage device. When the software detects that ESI is placed into the ESI storage device, the software may generate a second key. Where more than one item of ESI is placed into the ESI storage device, the software may generate more than one second key(s). Software on the first computer may transmit the second key(s) to a second computer. The second computer now may store both the first key(s) and the second key(s). Software on the second computer may compare the first key(s) and the second key(s). Software on the first computer may either manually or automatically generates a second key for the ESI. That second key may be transmitted to the remote or second computer containing the first key. Software on the remote or second computer may compare the first key and second key. The second key may or may not be stored on the remote or second computer.

The second computer in the authentication function may generate a report which reflects the results of the comparison of the first key(s) and the second key(s). Where the first key(s) and the second key(s) match, the ESI stored on a first computer of the authentication function is deemed authentic. Where the first key(s) and the second key(s) do not match, the ESI stored on a first computer of the authentication function is deemed not authentic. A report may be generated reflecting the comparison of the first key(s) and the second key(s).

The ESI may be stored in a database. The first key(s) and/or the second key(s) may be stored in a database. The term “database” as used in this application may be understood to include, but is not limited to, any structured set of data held in a computer.

The ESI may be a file. The first key(s) and/or the second key(s) may be files. The term “file” as used in this application may be understood to include, but is not limited to, any information stored on a computer as one unit or record. The ESI, the first key(s) and/or the second key(s) may be stored in folders. The term “folder” as used in this application may be understood to include, but is not limited to, any conceptual container for computer files in a computer operating system. Folders may include files corresponding to a directory, subdirectory or the like.

The first key(s) and/or the second key(s) may be stored in a remote location. The term “remote” as used in this application may be understood to include, but is not limited to, any relationship which is distant or removed in connection, relevance, or effect.

When the ESI from the key generation function is the same as the ESI from the authentication function, the hash values (or keys) will match. For example, let us assume that the ESI from the key generation function is a Tagged Image File Format (abbreviated TIFF) photograph image from a suspected crime scene. The TIFF image file may be generated by a camera. The key generation function will produce a first key based on the contents of the TIFF image. The first key is stored. Later, a prosecutor in a criminal trial has a second TIFF image. The prosecutor needs to demonstrate that the second TIFF image file is the same as the image from the suspected crime scene. The prosecutor uses a computer and software to generate a second key based on the second TIFF image file. The first key and the second key are compared. If the first key and the second key match, the prosecutor can be confident that the image from the suspected crime scene has not been altered in some way. If the first key and the second key do not match, the image from the suspected crime scene has been altered in some way. The image file may have been altered a little or maybe a lot, intentionally or inadvertently.

Software may be employed to monitor a folder in which ESI is located. The folder may be a repository for ESI. Any suitable method of monitoring for ESI may be employed. Each method of monitoring a folder or and ESI storage device may occur at a different implementation level, including application-level, operating system/kernel-level, firmware-level, and/or hardware-level. The application-level method may operate by executing code within the processing systems application area to capture file-system events. The operating system/kernel-level may integrate the code that captures file-system events into the operating system's code. File-system activities may be coordinated by the operating system. The firmware-level of implementation provides a hardware-level “hook” to capture file system events. Some digital cameras may use this monitoring method. Implementation at the hardware-level may require some manufactures to design hardware implementation with an eye toward the file system monitoring.

Operating system/kernel-level methods may use code that monitors file system events generated by a device's operating system. Code may read user-defined filters that ensure that events with specific attributes (like which directory the file is in) trigger a given business logic (e.g. generation of a first or second key for the ESI). For example, code may read a filter that ensures that, when a specific directory contains the ESI, the code may trigger key generation, such as the use of hashing. Once an event meeting the user's filter criteria is detected, it may be processed by business logic, which may include the generation of the first or second key for the ESI, temporarily queuing associated information locally, and transmitting that information to a remote host for storage and/or comparison.

Any suitable manner of creating a key may be employed as desired. Software may be employed to create a key (such as a hash value) of any file (such as ESI) inserted into a monitored folder. There are numerous ways to cryptographically hash a file in order to obtain a unique “fingerprint.” Any suitable cryptographic algorithm may be employed as desired. Industry standard hashing algorithms such as DSS, MD2, MD4, MD5, RIPEMD160, SHA, SHA1 (such as FIPS PUB 180-1), and others now in existence or later established to be suitable for this function may be employed. The National Institute of Standards and Technologies maintains documentation describing how many of these algorithms work. One or more account numbers and/or passwords may be may be used in association with hashing algorithms to produce a key employed in the system.

Any suitable manner of transmitting keys and files may be employed as desired. For example: FTP, HTTP, ICP and other protocols may be employed. Secure Hypertext Transport Protocol (HTTPS) using a Service Oriented Architecture (SOA) may be employed. The HTTPS connection may be made from a client to a server using industry standard methods built in to a client browser and web server. Once a connection is established, the client may submit information to a web service end-point that processes the data. When a connection can not be established via HTTPS, information is queued on a local machine. Once a connection is re-established, that queued information may be sent to the server using the SOA where the server may perform various functions like authenticating a user account, storing information, and retrieving one or more keys for file authentication.

Any suitable manner of authenticating a file or portion of ESI may be employed. An earlier generated first key may be compared to a later generated second key. The earlier generated first key and the later generated second key may be generated via the same cryptographic algorithm to facilitate comparison. One or more account numbers and/or passwords or other selected parameters may be may be used in association with hashing algorithms to produce a unique key employed in the system. The client may establishes a connection to a server and submit the key for authentication. The server performs a query of the account's stored keys. Since keys may be represented as a string of ASCII characters, a match is constituted by finding the ASCII equivalent of the two keys within a given storage medium (e.g. database). If a match is found, the server may respond with an “authenticated” message. If no match is found, the server may respond with a “not-authenticated” message. This comparison allows for an extremely high level of certainty in determining whether a first key and a second key match. This comparison allows for an extremely high level of certainty in determining whether the file in question is the same file that was hashed earlier.

Any suitable manner of reporting comparison information from a comparison of the first key and the second key. For example, a report can be displayed on the computer screen, be printed manually, be printed automatically, or any combination—as well as many other possibilities. In addition, there are many options on what/how the information on the report can be presented. However, no matter what method of generating a report for an authentication attempt uses or what information is presented, the report will always let the user know if a match was found (authenticated) or not (not-authenticated).

The invention may be made from any suitable material and by any suitable method. The invention may be adapted to fit a wide variety of uses. It will be appreciated that the components of the invention may be easily modified as needed to accommodate varying sizes and shapes.

The following source code in C# programming language may be employed. The invention is not thereby limited to the source code, though it may be helpful.

```
using Microsoft.Win32;
using System;
using System.Collections.Generic;
using System.Data.OleDb;
using System.IO;
using System.Text;
namespace authcon
{
    public class FileMonOptionItem
    {
        private bool changed = false;
        internal string filter = “*.*”;
        internal bool includeSubDirectories = true;
        internal uint internalBufferSize = 8192;
        internal NotifyFilters notifyFilters =
            System.IO.NotifyFilters.Attributes |
            System.IO.NotifyFilters.CreationTime |
            System.IO.NotifyFilters.DirectoryName |
            System.IO.NotifyFilters.FileName |
            System.IO.NotifyFilters.LastAccess |
            System.IO.NotifyFilters.LastWrite |
            System.IO.NotifyFilters.Security |
            System.IO.NotifyFilters.Size;
        internal string path = string.Empty;
        public bool Changed
        {
            get
            {
                return changed;
            }
        }
        public string Filter
        {
            get
            {
                return filter;
            }
            set
            {
                filter = value;
                changed = true;
            }
        }
        public bool IncludeSubDirectories
        {
            get
            {
                return includeSubDirectories;
        }
        set
        {
            includeSubDirectories = value;
            changed = true;
        }
    }
    public uint InternalBufferSize
    {
        get
        {
            return internalBufferSize;
        }
        set
        {
            internalBufferSize = value;
            changed = true;
        }
    }
    public NotifyFilters NotifyFilters
    {
        get
        {
            return notifyFilters;
        }
        set
        {
            notifyFilters = value;
            changed = true;
        }
    }
    public string Path
    {
        get
        {
            return path;
        }
        set
        {
            path = value;
            changed = true;
        }
    }
}
class FileMonOptions
{
        public List< FileMonOptionItem > Load( )
        {
            RegistryKey regRoot =
Utils.GetAuthCommonRegistryRoot(true);
            string dataSource = regRoot.GetValue(“DataSource”) as
string;
            DBConnectionMgr connMgr = new DBConnectionMgr(dataSource);
            OleDbConnection connection = connMgr.CreateConnection( );
            OleDbDataReader reader = null;
            List< FileMonOptionItem > optionList = new
List<FileMonOptionItem>( );
            try
            {
                connection.Open( );
                OleDbCommand command = connection.CreateCommand( );
                command.CommandType = System.Data.CommandType.Text;
                command.CommandText = “select Path, Filter,
IncludeSubDirectories, InternalBufferSize, NotifyFilter from
FSWConfig”;
                reader = command.ExecuteReader( );
                while (reader.Read( ))
                {
                    FileMonOptionItem item = new FileMonOptionItem( );
                    item.path = reader.GetString(0);
                    if (reader.GetValue(1) != DBNull.Value)
                    {
                        item.filter = reader.GetString(1);
                    }
                    else
                    {
                        item.filter = string.Empty;
                    }
                    if (reader.GetString(2) == “Y”)
                    {
                        item.includeSubDirectories = true;
                    }
                    else
                    {
                        item.includeSubDirectories = false;
                    }
                    item.internalBufferSize = (uint)reader.GetInt32(3);
                    NotifyFilters[ ] filters = new NotifyFilters[ ] {
                                    System.IO.NotifyFilters.Attributes,
System.IO.NotifyFilters.CreationTime,
System.IO.NotifyFilters.DirectoryName,
                                    System.IO.NotifyFilters.FileName,
                                    System.IO.NotifyFilters.LastAccess,
                                    System.IO.NotifyFilters.LastWrite,
                                    System.IO.NotifyFilters.Security,
                                    System.IO.NotifyFilters.Size
                    };
                    uint notifyFilters = (uint)reader.GetInt32(4);
                    item.notifyFilters = (NotifyFilters)0;
                    foreach (NotifyFilters nf in filters)
                    {
                        if ((notifyFilters & (uint)nf) == (uint)nf)
                        {
                            item.notifyFilters |= nf;
                        }
                    }
                    optionList.Add(item);
                }
            }
            finally
            {
                if (reader != null)
                {
                    reader.Close( );
                }
                connection.Close( );
            }
            return optionList;
        }
        public void Save(List< FileMonOptionItem > optionList)
        {
            RegistryKey regRoot =
Utils.GetAuthCommonRegistryRoot(true);
            string dataSource = regRoot.GetValue(“DataSource”) as
string;
            DBConnectionMgr connMgr = new DBConnectionMgr(dataSource);
            OleDbConnection connection = connMgr.CreateConnection( );
            try
            {
                connection.Open( );
                using (OleDbCommand command =
connection.CreateCommand( ))
                {
                    command.CommandType = System.Data.CommandType.Text;
                    command.CommandText = “delete from FSWConfig”;
                    command.ExecuteNonQuery( );
                }
                foreach (FileMonOptionItem item in optionList)
                {
                    using (OleDbCommand insertCommand =
connection.CreateCommand( ))
                    {
                        insertCommand.CommandType =
System.Data.CommandType.Text;
                        insertCommand.CommandText = “insert into
FSWConfig ([Path], [Filter], [IncludeSubDirectories],
[InternalBufferSize], [NotifyFilter]) values (?, ?, ?, ?, ?)”;
                        insertCommand.Parameters.Add(“@P1”,
OleDbType.VarChar, 255).Value = item.path;
                        insertCommand.Parameters.Add(“@P2”,
OleDbType.VarChar, 255).Value = item.filter;
                        insertCommand.Parameters.Add(“@P3”,
OleDbType.VarChar).Value = item.includeSubDirectories ? “Y” : “N”;
                        insertCommand.Parameters.Add(“@P4”,
OleDbType.Integer).Value = item.internalBufferSize;
                        insertCommand.Parameters.Add(“@P5”,
OleDbType.Integer).Value = item.notifyFilters;
                        insertCommand.ExecuteNonQuery( );
                    }
                }
            }
            finally
            {
                connection.Close( );
            }
        }
    }
}
```

It is to be understood that the invention is not limited in its application to the details of construction and to the arrangements of the components set forth in the accompanying description or illustrated in the drawings. The invention is capable of other embodiments and of being practiced and carried out in various ways. Also, it is to be understood that the phraseology and terminology employed herein are for the purpose of description and should not be regarded as limiting. The disclosure may readily be utilized as a basis for the designing of other structures, methods and systems for carrying out the present invention. It is important, therefore, that the claims be regarded as including equivalent constructions. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract and disclosure are neither intended to define the invention of the application, which is measured by the claims, nor are they intended to be limiting as to the scope of the invention in any way.

What is claimed is:

1. A system for authenticating electronically stored information (ESI) comprising:
an ESI-creation device which executes code which generates a first electronically stored information;
an ESI-storage device which executes code and stores the first electronically stored information where code generates a first key based on the first electronically stored information at a first earlier time and which transmits the first key and where code generates a second key based on a second electronically stored information at a second later time and which transmits the second key; and
a remote computer which executes code and receives the first key and the second key and compares the first key and the second key;
wherein the comparison of the first key and the second key are used to authenticate the second electronically stored information.

2. The system of claim 1 wherein the ESI-creation device is a camera.

3. The system of claim 2 wherein the first electronically stored information is a TIFF file.

4. The system of claim 1 wherein the first key and the second key are transmitted with a Secure Hypertext Transport Protocol.

5. The system of claim 4 wherein the first key and the second key are generated with a FIPS PUB 180-1 algorithm.

6. The system of claim 1 wherein the ESI-creation device is a computer.

7. The system of claim 6 wherein the first electronically stored information is a jpg file.

8. The system of claim 1 wherein the first key and the second key are transmitted with a File Transfer Protocol (FTP).

9. The system of claim 8 wherein the first key and the second key are generated with a SHA-1 algorithm.

10. The system of claim 8 where in the first key and the second key are generated with the MD5 algorithm.

11. A method for authenticating electronically stored information comprising:
providing a first electronically stored information onto a computer;
producing a first key from the first electronically stored information;
locating the first key at a location remote to the computer;
providing a second electronically stored information;
producing a second key from the second electronically stored information; and
comparing the first key and the second key.

12. The method of claim 11 wherein the electronically stored information is produced with a camera.

13. The method of claim 12 wherein the first electronically stored information is a TIFF file.

14. The method of claim 11 wherein the electronically stored information is produced with a mobile phone.

15. The method of claim 12 wherein the first electronically stored information is a jpg file.

16. A system for authenticating electronically stored information comprising:
a device which executes code which generates a first electronically stored information and stores the first electronically stored information and executes code which generates a first key based on the first electronically stored information at a first earlier time and which transmits the first key and executes code which generates a second key based on a second electronically stored information at a second later time and which transmits the second key; and
a remote computer which executes code which receives the first key and the second key and compares the first key and the second key;
wherein the comparison of the first key and the second key are used to authenticate the second electronically stored information.

17. The system of claim 16 wherein the ESI-creation device is a camera.

18. The system of claim 17 wherein the first electronically stored information is a TIFF file.

19. The system of claim 16 wherein the first key and the second key are transmitted with a Secure Hypertext Transport Protocol.

20. The system of claim 17 wherein the first key and the second key are generated with a FIPS PUB 180-1 algorithm.

21. The system of claim 16 wherein the ESI-creation device is a computer.

22. The system of claim 17 wherein the first electronically stored information is a jpg file.

23. The system of claim 16 wherein the first key and the second key are transmitted with a File Transfer Protocol (FTP).

24. The system of claim 17 wherein the first key and the second key are generated with a SHA-1 algorithm.

25. The system of claim 16 where in the first key and the second key are generated with the MD5 algorithm.
